(19) United States
(12) Patent Application Publication
(10) Pub. No.: US 2026/0289058 A1
(43) Pub. Date: Sep. 24, 2026

(54) RESET TESTING IN A PROCESSOR DESIGN ENVIRONMENT

(71) Applicant: Arm Limited, Cambridge (GB)

(72) Inventors: Adiel Sarusi, Kfar-Saba (IL); Lior-Levi Bandal, Kfar-Saba (IL); Yoav Asher LEVY, Kfar-Saba (IL)

(21) Appl. No.: 19/085,216

(22) Filed: Mar. 20, 2025

(51) Int. Cl. G06F 30/3308; G06F 30/31; G06F 115/10

(52) U.S. Cl. CPC G06F 30/3308; G06F 30/31; G06F 2115/10

(57) ABSTRACT

A method performs formal verification testing of reset values by: applying a hard reset action of a processor model implemented within an electronic design and automation tool; immediately after the hard reset action, reading a value of a register of the processor model; storing the register value in a memory; performing subsequent reset action upon the processing model; reading a subsequent value of the register; and comparing the register value and the subsequent value. A problem exists when the subsequent value is different from the register value stored in the memory. No problem exists when the subsequent value is equal to the register value stored in the memory. In certain embodiments, comparing the register value and the subsequent value is implemented using an assertion to trap an undesirable behavior of the subsequent reset action providing an improper value upon the subsequent reset action.

### BACKGROUND

Electronic design automation (EDA) tools assist in the design, implementation, simulation, verification, and subsequent manufacturing of semiconductor devices that include circuitry. Effectively, electronic design automation establishes a simulated world where circuits and designs are conceived and analyzed before making it to the real world.

Reset values are a fundamental aspect of electronic design of processors. Resets ensure that digital logic powers up into a known state, help prevent data shifting issues and help ensure stable and predictable system operation. Electronic design automation tools help identify redundant resets, can help manage reset domain crossing issues, and can help verify the correctness and quality of electronic systems.

### BRIEF SUMMARY

Reset testing in a processor design environment is described. The solution, which can be implemented within electronic design automation (EDA) tools, uses formal verification techniques (although in certain embodiments functional verification can be used) to ensure accurate testing of reset values in processing units. The formal verification technique is able to use assertions, which are statements used to trap undesirable behavior, such as the registers not possessing appropriate values upon reset. The solution involves reading registers after a reset and expecting the same value after another reset, which ensures that soft and hard resets are properly implemented. In certain embodiments, two checks are performed by the verification technique. A first check occurs after an initial (hard) reset to ensure the initial reset value is aligned with processor architecture specification (e.g., ARCH SPEC). The second check ensures a subsequent reset value (e.g., a soft/fast/SW reset) is aligned with the initial (hard) reset value.

In some aspects, a method performs formal verification testing of reset values by: applying a hard reset action of a processor model implemented within an electronic design and automation tool; immediately after the hard reset action, reading a value of a register of the processor model; storing the register value in a memory; performing subsequent reset action upon the processing model; reading a subsequent value of the register; and comparing the register value and the subsequent value. A problem exists when the subsequent value is different from the register value stored in the memory. No problem exists when the subsequent value is equal to the register value stored in the memory. The method can be repeated for all registers with asynchronous reset. In certain embodiments, comparing the register value and the subsequent value is implemented using an assertion to trap an undesirable behavior of the subsequent reset action providing an improper value upon the subsequent reset action. In some embodiments, the hard reset is a HW asynchronous reset. The subsequent reset can be either a HW asynchronous reset or a HW synchronous reset.

In some aspects, a computer-readable medium includes instructions that when executed by a computing system direct the computing system to: apply a hard reset action of a processor model implemented within an electronic design and automation tool; immediately after the hard reset action is performed, read a value of a register of a processor model implemented within an electronic design and automation tool, wherein the reading occurs immediately after a hard reset action; store the register value in a memory; perform subsequent reset action upon the processing model; read a subsequent value of the register; and compare the register value and the subsequent value.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates a representational diagram depicting stages of design of a circuit using an EDA tool.

FIG. 2A shows a flow chart for a method for verification testing of reset values.

FIG. 2B shows an embodiment of the flow chart of FIG. 2A for asserting a hard reset until after step 220 completes.

FIG. 2C shows an embodiment of the flow chart of FIG. 2A for gating the clock prior to performing the hard reset and re-enabling it after the register value is read.

FIG. 2D shows an embodiment of the flow chart of FIG. 2A for asserting a subsequent reset until after step 250 completes.

FIG. 2E shows an embodiment of the flow chart of FIG. 2A for gating the clock prior to performing the subsequent reset and re-enabling it after the register value is read.

FIG. 2F shows an embodiment of the flow chart of FIG. 2A for comparing the hard reset register value to the architecture specification.

FIG. 3A shows a flow diagram for reset checking using a formal verification technique.

FIG. 3B shows a flow diagram for reset checking against a specification using a formal verification technique and assertions.

FIG. 4 illustrates an example graphic user interface of an EDA tool.

FIG. 5 illustrates a schematic diagram illustrating components of a computing device that may be used in certain implementations described herein.

### DETAILED DESCRIPTION

Reset testing in a processor design environment is described. Careful design of reset logic is essential for proper processor operation. Electronic design automation (EDA) tools are used to simulate processor performance using a processor model (e.g., a register-transfer-level model) for pre-silicon verification of reset logic. Electronic design automation tools are able to detect many types of functional errors relating to reset logic early in the development process, when such errors are relatively easy to fix with minimal resource hits or schedule impacts. In certain embodiments, reset testing can occur before register lists have been established.

Resets can also be tested and verified later in the development cycle, such as by using gate-level simulations. For instance, power management often relies on the ability to turn portions of a design on and off. Modern processor development flows can add power-control logic to a design during logical synthesis, which produces a Unified Power Format (UPF) file. A reset analysis component of an electric design and automation tool reads the unified power format file, adds appropriate structures (clock-gating cells, isolation cells, etc.) to internal models to provide accuracy checks.

Generally, reset testing and verification is a significant and complex endeavor that occurs throughout a processor's development cycle. To elaborate on the complexity of reset testing, many processors have multiple resets triggered in different manners. Resets are often required for fatal error condition recovery, for recovery from deadlock or watchdog-timer expiration, for transient faults, for individual block power on from sleep or an off state, and for an initiation of a test or debug sequence. Processor designs often contain multiple asynchronous resets, with unique reset signals originating from different processor portions called reset domains. Signals traversing across reset domains creates a reset domain crossing (RCD). Improper handling of resource domain crossings leads to many serious problems.

Testing of reset values at various stages in the development process is enabled via a formal verification technique disclosed herein. In certain embodiments, techniques described herein can also be utilized for functional verification. Formal verification is a method to ensure that a hardware design (e.g., a processor model) behaves as intended by using mathematical analysis to check the design's correctness relative to the design's specification. Per the verification technique, a value of a register of a processor model implemented within an electronic design and automation tool is read immediately after a hard reset action. The register value is stored in a memory and is treated as though the register value is a ground truth value. In certain embodiments, after reading the value of the register post hard rest, the register value is compared with a corresponding value of the architecture specification (e.g., ARCH SPEC) of the processor model. When the register value is different from the corresponding value written in the architecture specification, the verification technique indicates a problem exists (e.g., an ERROR is thrown). A subsequent reset action is performed using the processing model, where a subsequent value of the register is read. The stored register value is compared to the subsequent value. A reset problem is indicated with the register when the subsequent value is different from the register value stored in the memory. It is determined that no problem exists when the subsequent value is equal to the register value stored in the memory. In certain embodiments, subsequent resets to the register's address are made via electronic design automation tool features. Reports can be constructed, which implement the reset verification test method detailed herein so that any register value mismatches are clearly identified within the reports, and steps to reconcile these mismatches can be taken. In certain embodiments, an assertion can be established to trap the undesirable behavior of a subsequent value for the subsequent reset action not equally the register value immediately after the hard reset action.

Reporting and/or verification features consistent with this disclosure can be integrated in various manners within electronic design automation tools.

Typical processor model designs contain hundreds of registers and register model generation used for reset testing is usually done by custom scripts or standard software tools like RALGEN from SYNOPSYS or RGM from CADENCE. These tools take the register specification as an input such as an IPXACT XML file in order to generate a SYSTEMVERILOG file, which contains fields and registers specified using standard UVM register classes.

The disclosed verification technique can interoperate with CANDENCE and existing tools. Moreover, the disclosed verification technique works for any generic block and is not dependent upon a register list being available. Our testing and verification can easily, almost effortlessly, generate a report for all registers, which can verify that soft/fast reset values are equal to the hard reset values for the registers. The disclosed verification technique allows for vanilla testing without verification engineering efforts, such as efforts traditionally needed for functional verification.

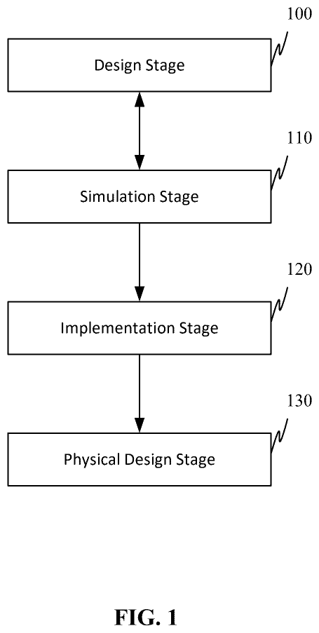

FIG. 1 illustrates a representational diagram depicting stages of design of a processor or other circuit using an EDA tool. Referring to FIG. 1, in a design stage 100, a designer designs the circuit which can be first designed as a schematic providing a graphical representation of the circuit, showing components and interconnections of the circuit and transformed into an RTL description creating a source design of the circuit. The RTL description can be represented in a hardware description language (e.g., VHDL or Verilog) which can then be further refined to precisely represent the circuit, specifying data flow and operations of the systems. A simulation stage 110 allows the designer to simulate and verify the operation of the source design of the circuit. In an implementation stage 120, the RTL source design is transformed into a gate level representation, such as a gate level netlist, that describes the connectivity of the circuit. The netlist includes instances which represent logic blocks comprising gates connected between terminals by intermediate nets, e.g., wires. In the implementation stage 120, a mathematical method is performed to verify the correctness of the RTL source design. During the implementation stage 120, optimizations can be performed on the source design (e.g. the logic blocks), for better performance of the circuit, for example through routing and power connections. Lastly, a physical layout of the optimized RTL source design of the circuit can be created in a physical design stage 130.

A processor model used for reset testing and verification can be enacted once the RTL source design has been represented in the hardware description language and reset values for a register are able to be read by an electronic design automation tool. The formal verification technique is not dependent on a registers list being ready. In the simulation stage 110, the processor model will be an RTL source design model, which can be used when verifying register reset values. In the implementation stage 120, register reset values can be verified using the formal verification technique, where the processor model can be a gate level model providing a gate level representation. For example, verifications of reset values affected by power control logic can occur during the implementation stage 120.

In certain embodiments, assertions can be used to trap an undesirable behavior of the subsequent value for the subsequent reset action not equaling the register value read immediately after the hard reset action. Thus, the disclosed reset value testing of registers can be an assertion-based formal verification technique the uses formal methods and assertions to analyze all possible states and behaviors of the processor model design. The assertions are statements embedded within a verification environment (e.g., a formal verification tool, which is a type of EDA tool) to identify design bugs and verify design correctness.

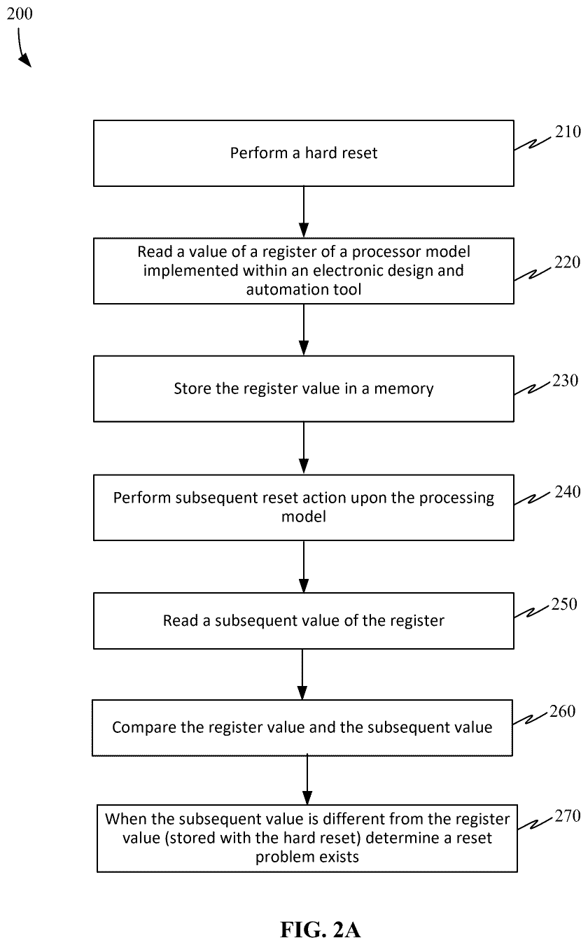

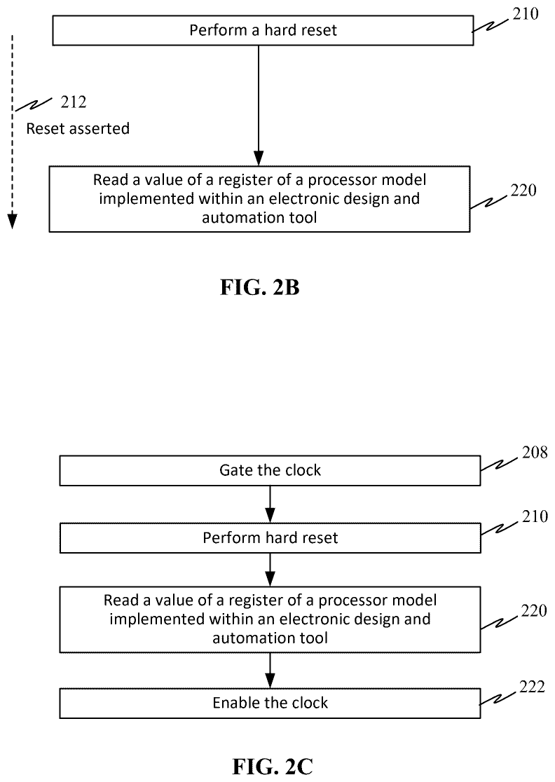

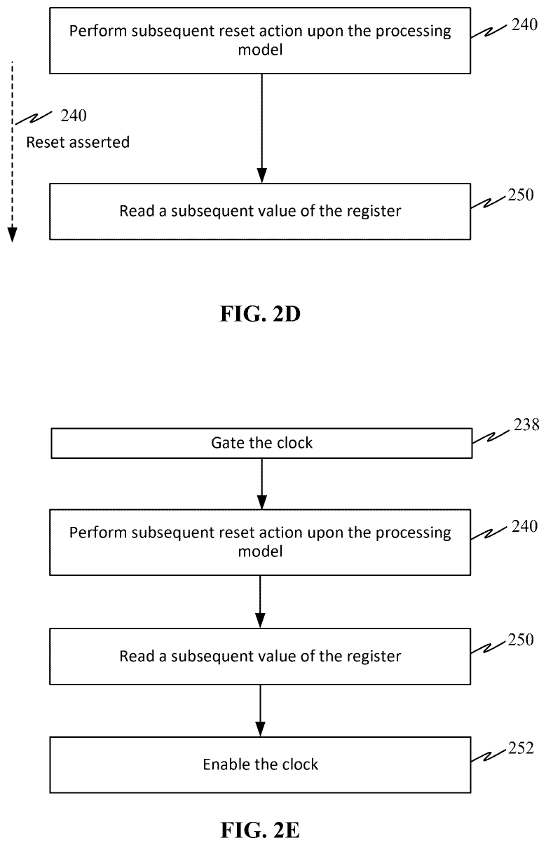

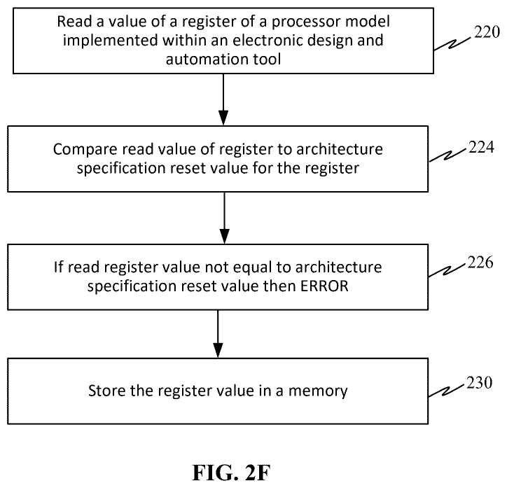

FIG. 2A shows a flow chart for a method 200 for formal (and function in some instances) verification testing of reset values. The method can be performed by an electronic design automation tool, application, scripts, and the like. The method is able to be performed at various stages in the processor design process and is not dependent on a registers list being ready, yet can be used to ensure all register values (or at least values for registers with asynchronous reset) of a register list (e.g., A UVM-register list) are proper. For example, each time a reset action occurs, a value of register addresses can be recorded post-reset. Confirmations of proper register values (or improper ones) can be organized as a report (or as variables) indexed against a register list (and its data structures). Further, although the method 200 shows a register verification process for a single register, establishment of logic (e.g., code/instructions) to utilize method 200 within a loop is contemplated, such that all register values (with asynchronous reset) or a subset of register values are tested/verified using method 200. An example of using a subset of values is to include all registers within a specific reset domain within a subset. Accordingly, steps 210, 220, 230, 240, 250, 260, and 270 can be repeated or looped for different registers and for different types of resets (e.g., hard, soft, fast, etc.).

In step 210, a hard reset is performed using an electronic design and automation tool. That is, the hard reset can be programmatic action triggered on a processor model under development as opposed to being performed mechanically on a physical hardware processor. Method 200 is not to be construed as limited to a design phase, however, and certain embodiments are contemplated where method 200 is performed on a physically implemented processor as an internal self-check. Steps can be taken (see FIGS. 2B and 2C) to ensure the reset value is correctly read and stored. The hard reset action can be a HW asynchronous reset.

In step 220, a value of a register of a processor model implemented with an electronic design tool can be read. The processor model can be a register-transfer level model having a register transfer level description represented in a hardware description language. The processor model can also be a gate-level model having a gate-level representation that describes connectivity of the circuit. Generally, the processor model is any model of a processor against which a hard reset can be effectuated and a register value existing immediately after the hard reset can be read. In certain embodiments (see FIG. 2F), the value resulting from the hard reset can be compared against a corresponding value of the architecture specification (ARCH SPEC).

In step 230, the register value can be stored in a memory. Storage of the register value in some fashion is needed in order to able to compare this value after a subsequent reset action. The register value can be stored in a variable of a data type used by the electronic design and automation tool or can be stored in a memory/file in any manner able to be subsequently accessed. The stored register value, achieved after a hard reset action/simulation, can be treated as a ground truth or as information known to be true. Should the register value resulting from the hard reset be inconsistent with a specification or documentation for the processor under development, attention to this disconnect should be immediately addressed at the earliest possible stage. Generally, inconsistencies discovered in step 270 will reveal additional inconsistencies, which are to be corrected.

In step 240, a subsequent reset action is performed upon the processing model. Steps can be taken (see FIGS. 2D and 2E) to ensure the subsequent reset value is correctly read. Any number of actions can be taken between step 220 and 240. For example, updates to the processing model, which is under development, can occur after the storing of the register value. The subsequent reset action can be performed after the updating occurs. Other actions can be unrelated to changing design characteristics of the processor model but involve changing values of the variables of the processor model. For example, after storing the register value, actions that inherently change the register value can occur prior to the second reset action. The second reset action should result in the same register value being read from the address associated with the register as the value resulting from the earlier hard reset action. In some embodiments, the second or subsequent reset action can be a HW asynchronous reset and/or a HW synchronous reset.

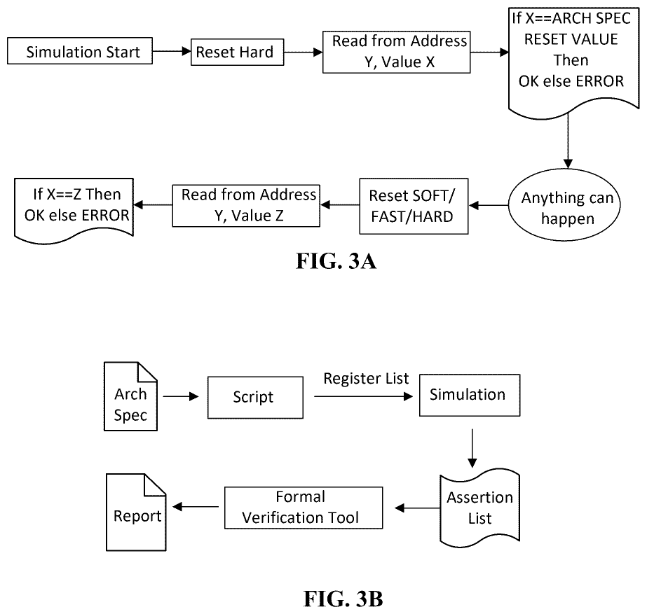

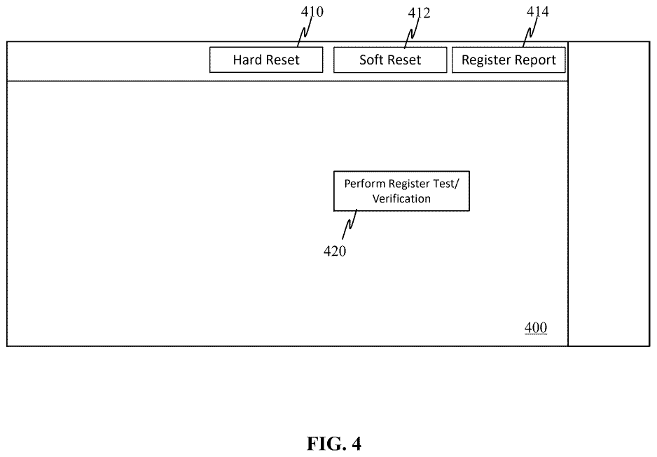

In step 250, a subsequent value of the register is read. In step 260, the register value is compared against the subsequent value. In step 270, when the subsequent value is different from the register value resulting from the hard reset action, a problem exists. In almost all situations (i.e., over 99% of the time) the subsequent reset value should be equal to the hard reset value. However, specific very rare cases do exist, where soft reset functionality is intentionally different from hard reset functionality such that the soft reset value (of a synchronous reset for example) is intended to be different from the hard rest value (of an asynchronous reset). In such very rare cases, the check performed in step 260 can be disabled and/or the problem indicated by step 270 should be suppressed or ignored by a user. After step 270, a report, notification, or other indication to this effect can be automatically generated or triggered. In certain embodiments, the comparing of step 250 is implemented as an assertion. (See FIG. 3B)

The subsequent reset action can be a soft, fast, or hard reset action. The subsequent reset action can be HW asynchronous and/or HW synchronous. Further, the reset of step 240 can be issued from any processor portion of the processor model, which means method 200 is able to handle reset domain crossings. That is, the processor model can have a plurality of reset domains, wherein the subsequent reset action corresponds to a different reset domain from that of the hard reset action. The subsequent reset action can be triggered by one of a fatal error condition recovery, a recovery from deadlock or watchdog-timer expiration, a transient fault, individual block power on from sleep or an off state, and an initiation of a test or debug sequence.

In some embodiments, steps 240, 250, 260, and 270 can be repeated for different types and instances of reset actions for a single register. For example, two different soft reset actions can occur, which are each compared to the stored register value (resulting from the hard reset). Application of an additional hard reset and a storing of the register value (which should not change) is not required between subsequent reset action(s) (e.g., an instance of step 240).

FIG. 2B shows an embodiment of the flow chart of FIG. 2A for asserting a hard reset until after step 220 completes. In step 212, a hard reset is asserted until step 220 completes, which ensures the reset value is proper. Otherwise, situations exist where the value may be wrong.

FIG. 2C shows an embodiment of the flow chart of FIG. 2A for gating the clock prior to performing the hard reset and re-enabling it after the register value is read. In step 208, the clock is gated/disabled. The hard reset action is performed in step 210. The value of the register of the processor model is read in step 220. In step 222, the clock is enabled/re-enabled. FIG. 2C represents an alternative means to ensure the value of the register is proper.

FIG. 2D shows an embodiment of the flow chart of FIG. 2A for asserting a subsequent reset until after step 250 completes. In step 242, a subsequent reset is asserted until step 250 completes, which ensures the reset value per the subsequent reset action is proper. Otherwise, situations exist where the subsequent value may be wrong.

FIG. 2E shows an embodiment of the flow chart of FIG. 2A for gating the clock prior to performing the subsequent reset and re-enabling it after the register value is read. In step 238, the clock is gated/disabled. The subsequent reset action is performed in step 240. The subsequent value of the register of the processor model is read in step 250. In step 252, the clock is enabled/re-enabled. FIG. 2E represents an alternative means to ensure the subsequent value of the register is proper.

FIG. 2F shows an embodiment of the flow chart of FIG. 2A for comparing the hard reset register value to the architecture specification. Per FIG. 2F, the verification technique performs two checks. A first check ensures that the reset value is aligned to the processor architecture specification. The second check ensures that the reset value is equal for different resets. In step 220, a value of a register is read (immediately after a hard reset). In step 224, the read value of the register is compared to a processor architecture specification reset value for that register. In step 226, if the read register value is not equal to the corresponding value of the architecture specification an ERROR occurs. The hardware reset value is wrong (or inconsistent with the architecture specification). Assuming on ERROR, the register value is stored in a memory and the method continues as described with reference to FIG. 2A.

FIG. 3A shows a flow diagram for reset checking using a formal verification technique. FIG. 3B shows a flow diagram for reset checking against a specification using a formal verification technique and assertions. FIGS. 3A and 3B, which are consistent with FIG. 2A, are used to present a specific use case and instance. At various points in a processor development cycle lots of registers have changed address and reset specifics over early stages. Register tests can be read one after the other to try to retrieve unique values or to prove that unique values do not exist. Since not all registers are Write-Read, logic is necessarily toggled in order to correctly fill the registers with interesting values to be tested. Conventional register tests are expensive and require significant effort from verification engineers.

An assumption for certain embodiments of FIGS. 3A and 3B is that for the processor model and relevant registers, floating point operations per second (FLOP) have an asynchronous reset. That is, reading from the address Y in FIG. 3A assumes an asynchronous reset. The assertion list of FIG. 3B is only for FLOPs that have asynchronous reset after filtering FLOPs that do not have asynchronous reset (i.e., mostly data FLOPs). A common flow for a specific use case can include:

```
  All_register( ) = from arch spec using arch spec to registers list using script
  get_all_supported_reset(register_name) = return all resets(pin/soft/fast) and reset
values expected for that register.
Reset the block
For each register do read after reset and compare to value from arch spec
```

FIG. 3A resolves a problem of verifying that pin/Soft/fast reset actions affect all registers of GM verses R0. Assume a flow that begins with a simulation start, where a hard reset is performed that reads Value X from Address Y. In some embodiments, the Value X can be compared to a corresponding reset value specified in the processor architecture specification. If different, an error occurs (see FIG. 2F). Time can pass and changes can occur (e.g., anything can happen such as register values changing or even design updates of the processing model itself can occur). Then, a subsequent reset (e.g., soft/fast/hard) occurs. After the subsequent reset, a Value Z (e.g., subsequent value) is read from Address Y. If X==Z then the rest action is OK, else and error occurred.

The flow represented by FIG. 3A for the use case includes:

```
For Each register Y in All_register:
  Check for reset_X in get_all_supported_reset(Y):
    Assertion that for register Y after a reset_X is back to reset value
```

Method 200 and the flow of FIG. 3A provides a technique to test reset values for any generic block by performing a read right after a hard reset and then expecting a subsequent read value of the register to be the same after another reset occurs. Thus, the reset verification technique permits formal verification that register values resulting from soft resets are then same as those for hard resets. This permits processor developers to ensure that no register reset values have been overlooked or are missing. Further, all registers (or any subset thereof) are able to be effortlessly checked at once verses having to conduct expensive functional verifications to achieve the same level of assurance.

Referring to FIG. 3B, a script can create a register list from the architecture specification. Simulations can be run with aid of an assertion list. A formal verification tool, such as JASPER GOLD can be used to generate a report, which shows formal verification results to ensure reset values of the registers match design specifications (e.g., the architecture specification).

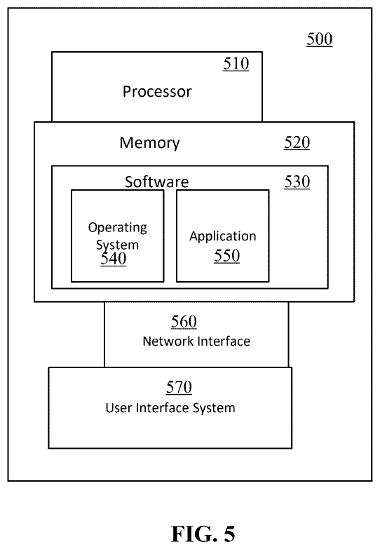

FIG. 4 illustrates an example graphic user interface of an EDA tool. Referring to FIG. 4, the example graphic user interface 400 can be the interface of an EDA tool in which various operations of processor design implementation are carried out, which include testing register values for various reset actions. In some cases, the designer can interact with graphic user interface 400, for example by selecting a hard reset 410 is applied, which performs a hard reset action and stores register values immediately after (see steps 220 and 230 of FIG. 2A). A subsequent soft reset 412 (or other reset) action can be triggered, where register values are read immediately after (see step 250). When the soft reset 412 occurs, a register test/verification action 420 is performed (see step 260 and 270). In some embodiment, a report 414 feature can be enabled to generate a report that tests each register value after an occurrence of various resets.

It should be understood that the illustrated example is merely representative of potential functionality of an EDA tool and corresponding graphic user interface. In addition, different mechanisms for accessing method 200 may be provided, along with different interfaces and visual cues. For example, a stand-alone tool may also be provided.

FIG. 5 illustrates a schematic diagram illustrating components of a computing device that may be used in certain implementations described herein. The computing device can be representative of a computing device on which an EDA tool runs as well as the methods for post-implementation verification of the source design of a circuit as described herein. Referring to FIG. 5, computing device 500 can represent a personal computer, a mobile device, a tablet, a laptop computer, a desktop computer, a server, or a smart television as some examples. Accordingly, more or fewer elements described with respect to computing device 500 may be incorporated to implement a particular computing device.

Referring to FIG. 5, computing device 500 can include at least one processor 510, a memory 520, software 530 that includes operating system 540 and application 550 stored in the memory 520, network interface 560, and user interface 570. Processor 510 processes data and performs operations according to instructions of software 530. The instructions of application 550 may be loaded into computing device 500 and run on or in association with the operating system 540. Application 550 can include the methods as described (e.g., method 200), the EDA tool, or both (e.g., the methods integrated into the EDA tool, a plug-in and the EDA tool, separate applications, etc.). Memory 520 may comprise any computer readable storage media readable by processor 510 and capable of storing software 530 including application 550. Memory 520 (and any computer-readable storage media forming memory 520) does not consist of propagating signals nor is memory 520 to be considered transitory media. A computer readable medium (or storage medium) can include instructions stored thereon. The instructions when executed by the computing system or computing device 500 direct the computer system to perform the methods detailed herein (see FIGS. 2A, 2B, 2C, 2D, 2E, and 2F).

Computing device 500 can further include a user interface 570, which may include input/output (I/O) devices and components that enable communication between a user and the computing device 500 such as, but not limited to, a display, keyboard, mouse, microphone, and speakers. Computing device 500 may also include a network interface 560 that allows the system to communicate with other computing devices, including server computing devices and other client devices, over a network. Network interface 560 can include wired and/or wireless interfaces of one or more communication protocols and/or ports (e.g., for wifi or Ethernet, BLUETOOTH, near field communication (NFC), etc.)

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts that would be recognized by one skilled in the art are intended to be within the scope of the claims.

What is claimed is:

1. A method for verification testing of reset values comprising:
applying a hard reset action of a processor model implemented within an electronic design and automation tool;
immediately after the hard reset action, reading a value of a register of the processor model;
storing the register value in a memory;
performing a subsequent reset action upon the processor model;
reading a subsequent value of the register; and
comparing the register value and the subsequent value.

2. The method of claim 1, wherein the verification is a formal verification technique.

3. The method of claim 1, wherein the verification is a functional verification technique.

4. The method of claim 2, wherein the comparing is implemented using an assertion to trap an undesirable behavior of the subsequent value for the subsequent reset action not equaling the register value read immediately after the hard reset action.

5. The method of claim 1, further comprising:
indicating a problem exists when the subsequent value is different from the register value stored in the memory.

6. The method of claim 1, further comprising:
determining no problem exists when the subsequent value is equal to the register value stored in the memory.

7. The method of claim 1, further comprising:
after the storing, updating the processor model, wherein the subsequent reset action is performed after the updating.

8. The method of claim 1, further comprising:
after the storing, performing actions against the processor model, said actions changing the register value.

9. The method of claim 1, further comprising:
repeating the applying, the reading of the value, the storing, the performing, the reading of the subsequent value, and the comparing for every register of the processor model.

10. The method of claim 1, wherein the hard reset action is a HW asynchronous reset.

11. The method of claim 1, wherein the subsequent reset action is one of a software reset action and a fast reset action.

12. The method of claim 1, wherein the subsequent reset action is triggered by one of a fatal error condition recovery, a recovery from deadlock or watchdog-timer expiration, a transient fault, individual block power on from sleep or an off state, and an initiation of a test or debug sequence.

13. The method of claim 1, wherein the processor model has a plurality of reset domains, wherein the subsequent reset action corresponds to a different reset domain from that of the hard reset action.

14. The method of claim 1, wherein the processor model is a register-transfer level (RTL) model.

15. The method of claim 1, wherein the method is performed after an implementation stage of circuit design in an electronic design automation (EDA) tool.

16. The method of claim 1, wherein the subsequent reset is a HW asynchronous reset.

17. The method of claim 1, wherein the subsequent reset is a HW synchronous reset.

18. The method of claim 1, further comprising:
after reading the value of the register, comparing the register value with a corresponding value written in an architecture specification of the processor model.

19. The method of claim 18, further comprising:
indicating a problem exists when the register value is different from the corresponding value written in the architecture specification.

20. A computer-readable medium comprising instructions stored thereon, the instructions
when executed by a computing system direct the computing system to:
apply a hard reset action of a processor model implemented within an electronic design and automation tool;
immediately after the hard reset action, read a value of a register of the processor model;
store the register value in a memory;
perform a subsequent reset action upon the processor model;
read a subsequent value of the register; and
compare the register value and the subsequent value.
